(19) United States
(12) Patent Application Publication
(10) Pub. No.: US 2013/0321377 A1
(43) Pub. Date: Dec. 5, 2013

(54) DRIVING DEVICE OF IMAGE DISPLAY MEDIUM, IMAGE DISPLAY APPARATUS, DRIVING METHOD OF IMAGE DISPLAY MEDIUM, AND NON-TRANSITORY COMPUTER READABLE MEDIUM

(71) Applicant: FUJI XEROX CO., LTD., Tokyo (JP)

(72) Inventors: Masaaki ABE, Kanagawa (JP); Yasufumi SUWABE, Kanagawa (JP); Yoshinori MACHIDA, Kanagawa (JP)

(73) Assignee: FUJI XEROX CO., LTD., Tokyo (JP)

(21) Appl. No.: 13/656,145

(22) Filed: Oct. 19, 2012

(30) Foreign Application Priority Data
May 31, 2012 (JP) 2012-124331

(51) Int. Cl. G06F 3/038

(52) U.S. Cl. 345/212

(57) ABSTRACT

Provided is a driving device of an image display medium which includes a pair of substrates having a transparent display substrate and a back substrate disposed so as to be opposite to the display substrate with a gap therebetween, a first electrode provided on the display substrate side, plural second electrodes provided on the back substrate side, and particles sealed between the pair of substrates, and which displays an image on the basis of image information,
the driving device including:
a voltage applying unit that applies a voltage to the pair of substrates of the image display medium; and
a controller that controls the voltage applying unit on the basis of the image information such that a variation of a driving voltage between adjacent second electrodes is provided with respect to adjacent pixels that display the same density.

### CROSS-REFERENCE TO RELATED APPLICATIONS

This application is based on and claims priority under 35 USC 119 from Japanese Patent Application No. 2012-124331 filed May 31, 2012.

### BACKGROUND

(i) Technical Field

The present invention relates to a driving device of an image display medium, an image display apparatus, a driving method of an image display medium, and a non-transitory computer readable medium.

(ii) Related Art

In the related art, an image display medium using a colored particle is known as an image display medium which has a memory property and may be repeatedly rewritten. The image display medium includes, for example, a pair of substrates and plural kinds of particle groups which are sealed between substrates so as to be movable between the substrates due to an electric field applied to the pair of substrates and have different colors and charging characteristics.

In this image display medium, particles are moved by applying a voltage corresponding to an image between a pair of substrates, and the image is displayed as a contrast of particles of different colors.

### SUMMARY

According to an aspect of the invention, there is provided a driving device of an image display medium which includes a pair of substrates having a transparent display substrate and a back substrate disposed so as to be opposite to the display substrate with a gap therebetween, a first electrode provided on the display substrate side, plural second electrodes provided on the back substrate side, and particles sealed between the pair of substrates and detached from either of the pair of substrates by a voltage applied to the pair of substrates in a state of being attached to the substrate, and which displays an image on the basis of image information,

the driving device including:

a voltage applying unit that applies a voltage to the pair of substrates of the image display medium; and

a controller that controls the voltage applying unit on the basis of the image information such that a variation of a driving voltage between adjacent second electrodes is provided with respect to adjacent pixels that display the same density.

### BRIEF DESCRIPTION OF THE DRAWINGS

Exemplary embodiments of the present invention will be described in detail based on the following figures, wherein:

FIG. 1A is a schematic diagram of an image display apparatus according to an exemplary embodiment of the invention;

FIG. 1B is a block diagram illustrating a configuration of a controller of the image display apparatus according to the exemplary embodiment of the invention;

FIG. 2 is a diagram illustrating an example of charge characteristics of a migrating particle group sealed in the image display medium according to the exemplary embodiment;

FIG. 3A is a diagram illustrating a first example of the driving voltage which generates a potential difference between adjacent electrodes;

FIG. 3B is a diagram illustrating a second example of the driving voltage which generates a potential difference between adjacent electrodes;

FIG. 4A is a diagram illustrating a third example of the driving voltage which generates a potential difference between adjacent electrodes;

FIG. 4B is a diagram illustrating a fourth example of the driving voltage which generates a potential difference between adjacent electrodes;

FIGS. 5A to 5C are diagrams illustrating an operation of the image display apparatus according to the exemplary embodiment; and

FIGS. 6A to 6D are diagrams illustrating an example of the driving method of migrating particles in the related art.

### DETAILED DESCRIPTION

Hereinafter, exemplary embodiments of the invention will be described with reference to the drawings. The members having the same operation or function are given the same reference numerals through the overall drawings, and repeated description is omitted in some cases. In addition, for simplicity of description, the exemplary embodiment will be described with reference to the figures in which attention is paid to an appropriate single cell.

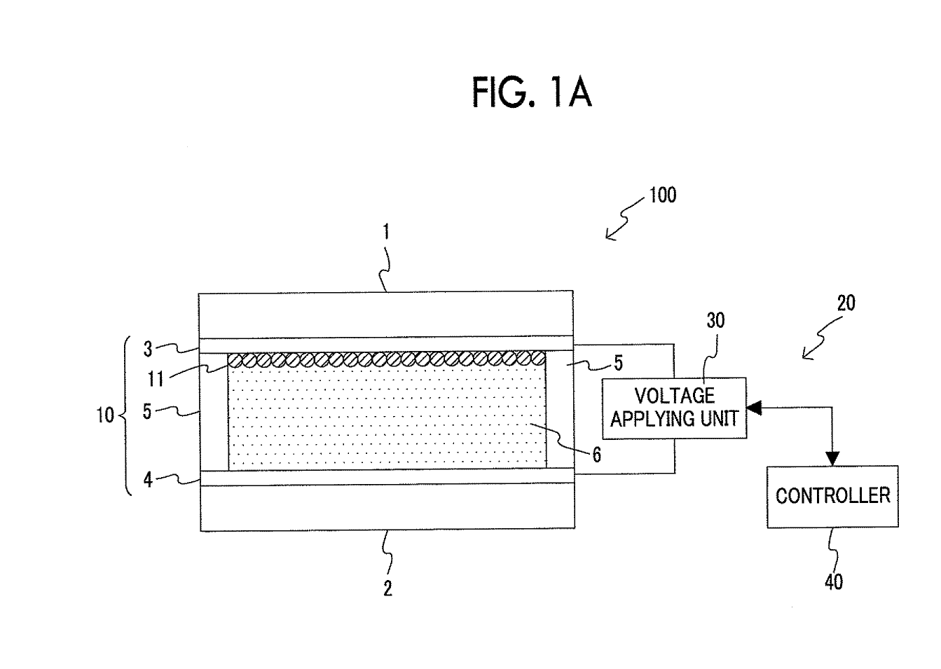

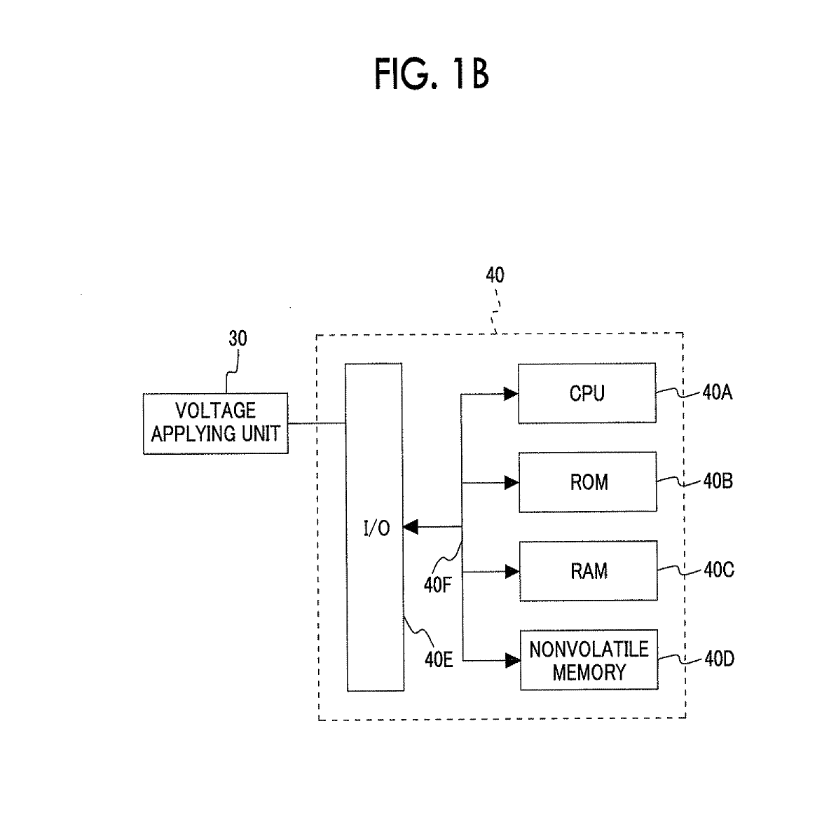

FIG. 1A schematically illustrates an image display apparatus according to the exemplary embodiment. The image display apparatus 100 includes an image display medium 10 and a driving device 20 which drives the image display medium 10. The driving device 20 includes a voltage applying unit 30 which applies a voltage between a display side electrode 3 and a back surface side electrode 4 of the image display medium 10, and a controller 40 which controls the voltage applying unit 30 according to image information of an image displayed on the image display medium 10.

The image display medium 10 has a pair of substrates in which a transparent display substrate 1 which is an image display surface and a back surface substrate 2 which is a non-display surface are disposed so as to be opposite to each other with a gap therebetween.

A gap member 5 which holds the substrates 1 and 2 in a predefined gap and partitions a space between the substrates into plural cells is provided.

The cell indicates a region surrounded by the back surface substrate 2 provided with the back surface side electrode 4, the display substrate 1 provided with the display side electrode 3, and the gap member 5. In addition, a single cell includes plural pixels.

In the cell, for example, a dispersion medium 6 constituted by an insulating liquid, and a migrating particle group 11 dispersed in the dispersion medium 6 are sealed. The migrating particle group 11 is colored in a predefined color and has charge characteristics, and the colored particle group 11 migrates between the substrates by controlling a voltage applied to a pair of electrodes 3 and 4.

Although, in the exemplary embodiment, an example where the migrating particle group 11 colored in one kind of predetermined color is sealed is described, plural kinds of particle groups may be sealed between the substrates. In a case where plural kinds of colored particle groups are sealed between the substrates, migrating particle groups having different colors and charge characteristics may be sealed, or a floating particle group (for example, a particle group which has a charge amount smaller than the migrating particle group 11 and does not move to any electrode side even if a voltage for moving the migrating particle group 11 to the electrode side is applied) which do not have charge characteristics and float may be included. As the floating particle group, a white-colored particle group which is colored white may be employed so as to display white. Alternatively, a color (for example, white) different from colors of the migrating particles may be displayed by mixing the dispersion medium with a colorant.

The driving device 20 (the voltage applying unit 30 and the controller 40) controls a voltage applied between the display side electrode 3 and the back surface side electrode 4 of the image display medium 10 according to a display color such that the migrating particle group 11 migrates and thereby is pulled to either of the display substrate 1 and the back surface substrate 2 according to a charged polarity of each of the particles.

The voltage applying unit 30 is electrically connected to the display side electrode 3 and the back surface side electrode 4. In addition, the voltage applying unit 30 is connected to the controller 40 such that a signal is sent and received therebetween.

The controller 40 is constituted as, for example, a computer 40 as illustrated in FIG. 1B. The computer 40 includes, for example, a Central Processing Unit (CPU) 40A, a Read Only Memory (ROM) 40B, a Random Access Memory (RAM) 400, a nonvolatile memory 40D, and an input and output interface (I/O) 40E, which are connected to each other via a bus 40F, and the I/O 40E is connected to the voltage applying unit 30. In this case, a program causing the computer 40 to execute a process for instructing the voltage applying unit 30 to apply a voltage necessary for display of each color is written in, for example, the nonvolatile memory 40D, and the CPU 40A reads and executes the program. In addition, the program may be provided using a recording medium such as a CD-ROM.

The voltage applying unit 30 is a voltage applying device for applying a voltage to the display side electrode 3 and the back surface side electrode 4, and applies a voltage responding to the control of the controller 40 to the display side electrode 3 and the back surface side electrode 4. The voltage applying unit 30 may employ an active matrix type or a passive matrix type. Alternatively, a segment type may be employed.

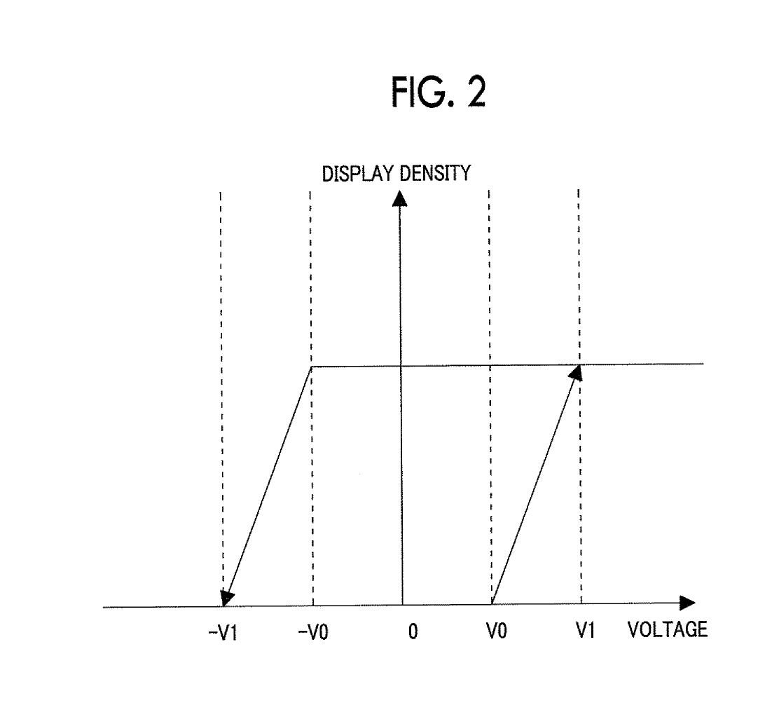

FIG. 2 is an example of the charge characteristics of the migrating particle group sealed in the image display medium 10 according to the exemplary embodiment. FIG. 2 illustrates an example where the display side electrode 3 is set to a ground voltage (0 V), and a driving voltage is applied to the back surface side electrode 4.

In the exemplary embodiment, the migrating particle group 11 has a positive charge characteristic. The attachment force of the migrating particle group 11 to the substrate is set by setting a charge amount, a particle diameter (volume average particle diameter) and the like. In the exemplary embodiment, if a voltage of |V0| or more is applied, the migrating particle group 11 starts to move between the substrates, and, the migrating particle group moving to either substrate is set to be attached to the substrate at a voltage |V1| (V0<V1).

However, in a case of driving the migrating particle group 11 sealed in the image display medium 10 according to the exemplary embodiment, the movement of the migrating particle group 11 is controlled so as to display an image by applying a voltage between the display substrate 1 and the back surface substrate 2 on the basis of the characteristics of the migrating particle group illustrated in FIG. 2 and image information in the related.

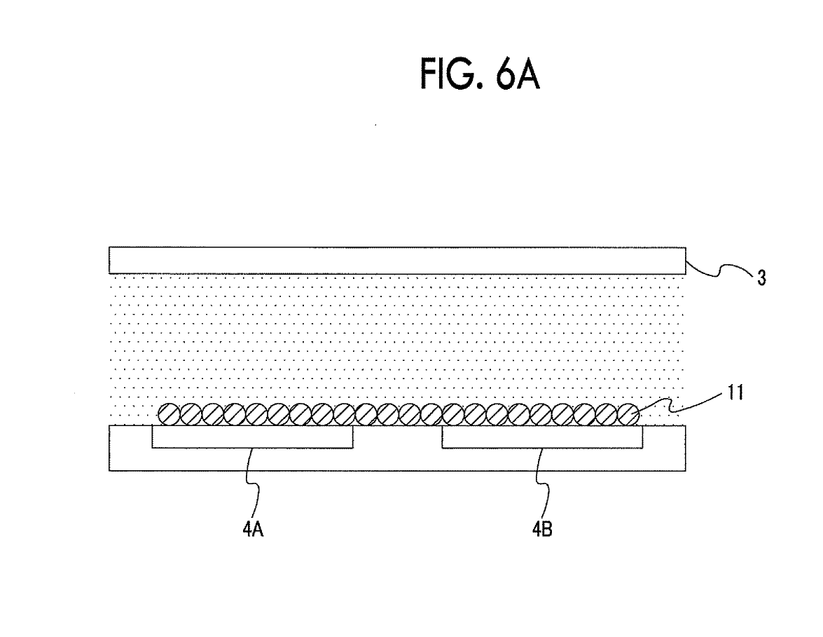

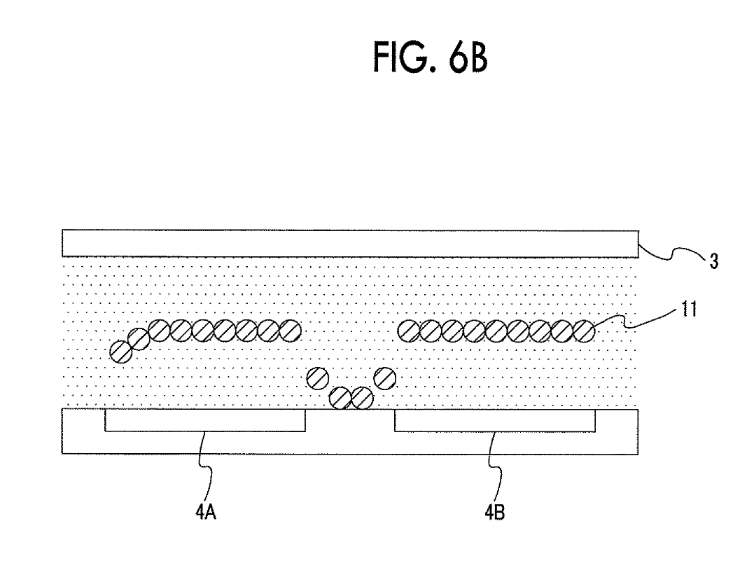

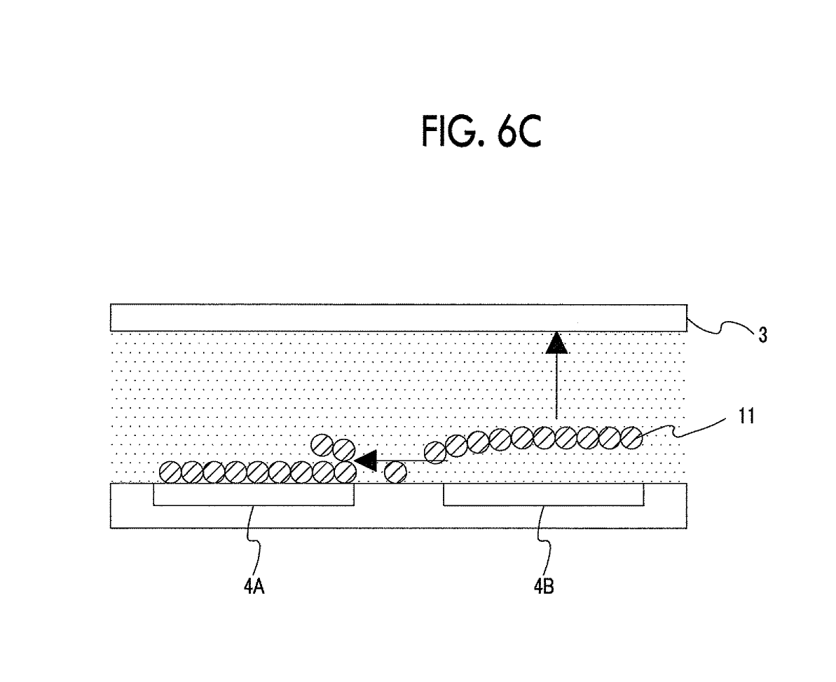

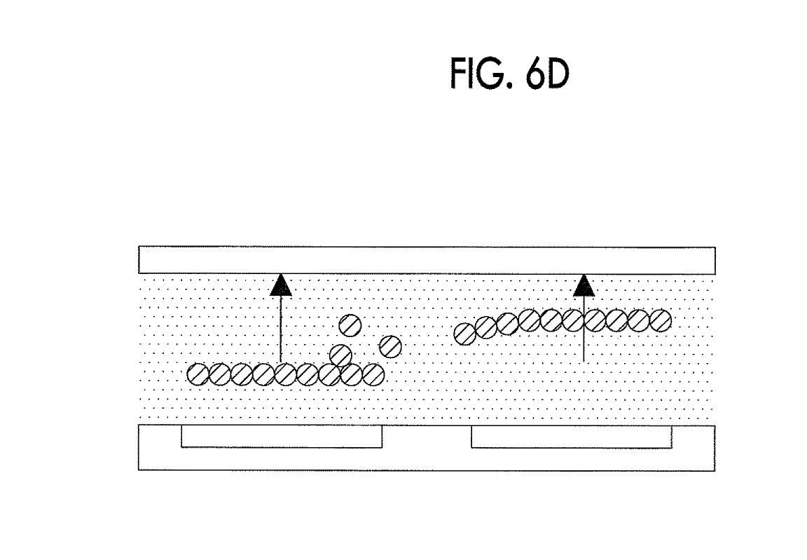

However, after the migrating particle group 11 is driven, the migrating particle group 11 is attached between adjacent electrodes, and thus controllability of the particles deteriorates. Particularly, when adjacent pixels display the same display density, the particles are attached between adjacent electrodes, and thus the controllability of the particles deteriorates. For example, as illustrated in FIG. 6A, in a case where the migrating particle group 11 moves to the display side electrode 3 side in a state where the migrating particle group 11 is attached to the back surface side electrode 4 side, peeling of the particles attached between the back surface side electrodes 4 from the substrate is delayed as illustrated in FIG. 6B, and thus the controllability of the particles deteriorates. In other words, due to the delay of the peeling of the migrating particles from the substrate, all of the migrating particles may not move during a voltage application period, and thereby the contrast or the resolution is reduced.

In order to address it, in the related technique, preliminary driving is performed. In other words, the attached migrating particle group 11 is temporarily peeled by performing the preliminary driving before applying a display voltage (FIG. 6C), and then the migrating particle group 11 is driven (FIG. 6D), thereby suppressing deterioration in the controllability of the migrating particles as described above. According to the technique, it is possible to suppress deterioration in the controllability, but a voltage other than a driving voltage for display is required to be applied in order to perform preliminary driving.

Therefore, in the exemplary embodiment, the controller 40 controls the voltage applying unit 30 such that a variation in which a potential difference is generated between adjacent electrodes is provided in an application period of a driving voltage for display without performing driving separate from application of the driving voltage for display such as preliminary driving, thereby applying the driving voltage for display between the substrates.

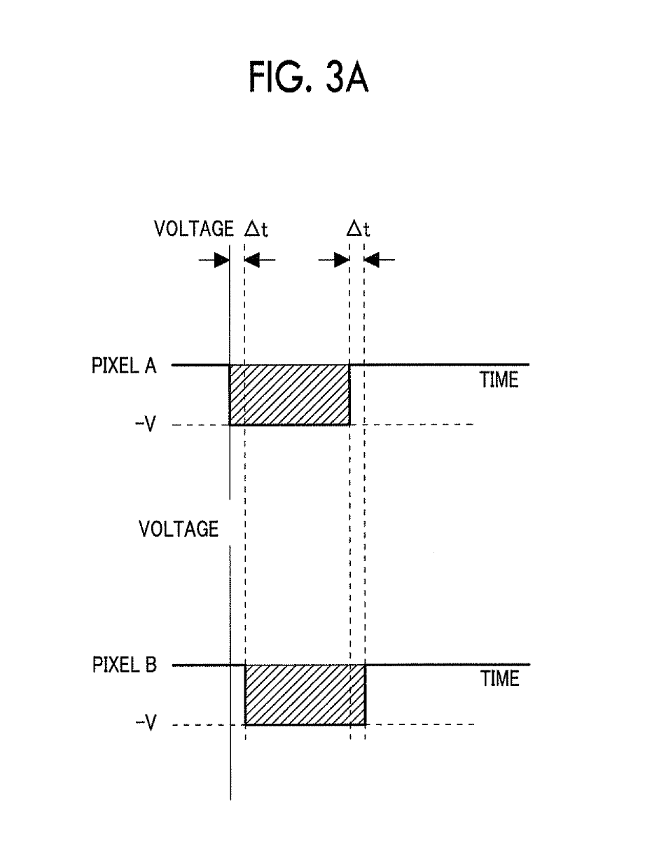

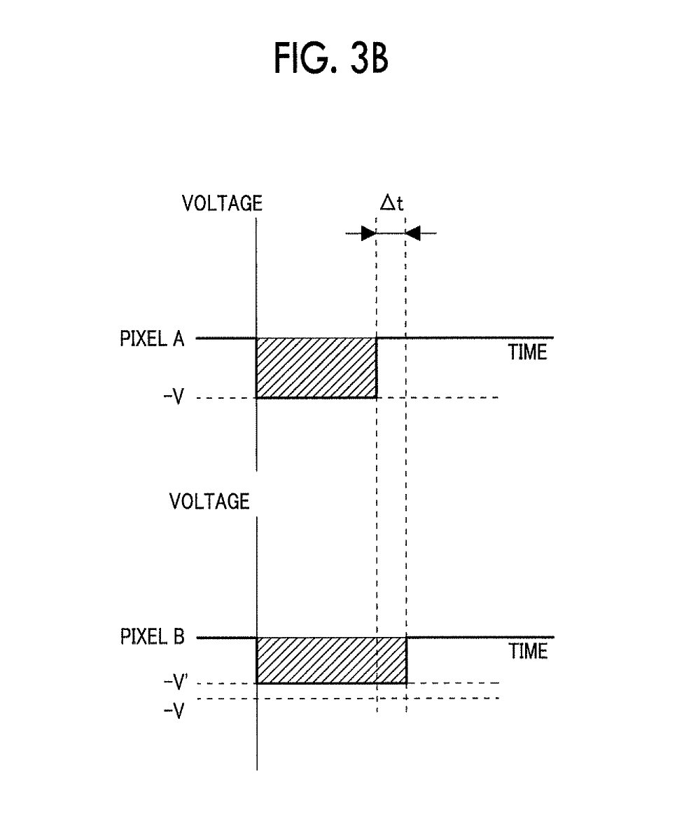

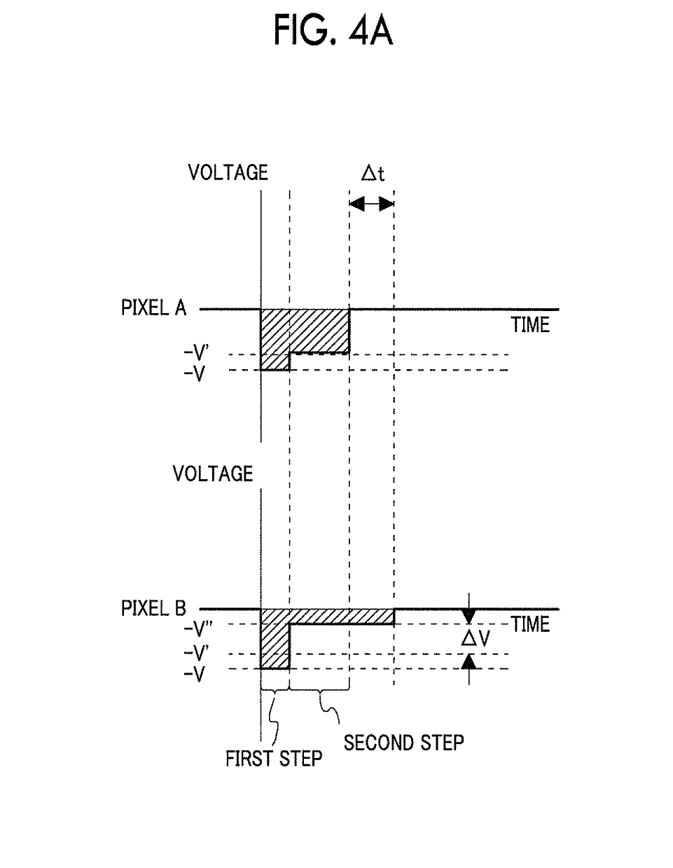

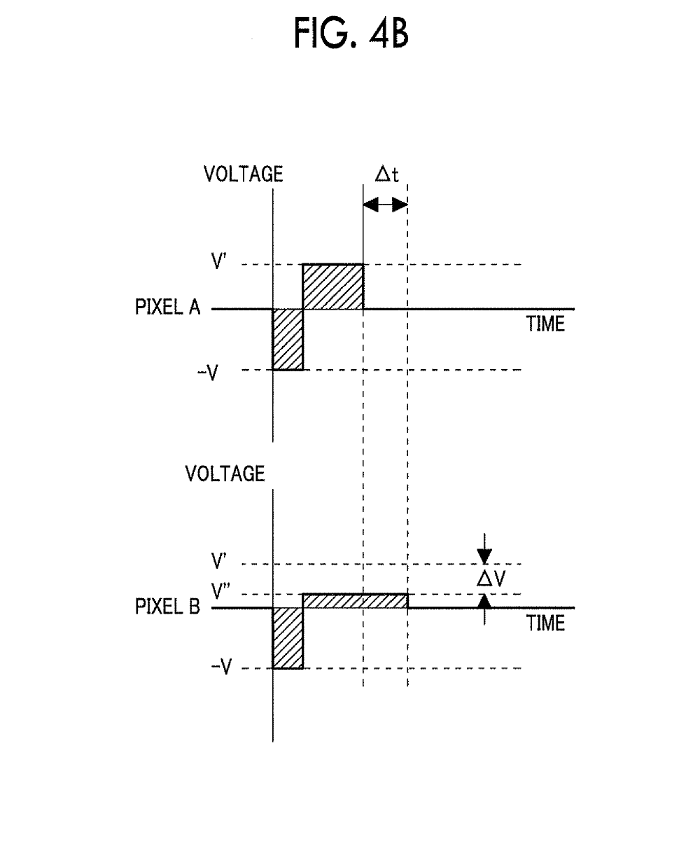

Here, a description will be made of an example of the driving voltage of the image display apparatus according to the exemplary embodiment. FIG. 3A is a diagram illustrating a first example of the driving voltage for generating a potential difference between adjacent electrodes; FIG. 3B is a diagram illustrating a second example of the driving voltage for generating a potential difference between adjacent electrodes; FIG. 4A is a diagram illustrating a third example of the driving voltage for generating a potential difference between adjacent electrodes; and FIG. 4B is a diagram illustrating a fourth example of the driving voltage for generating a potential difference between adjacent electrodes.

In the first example of the driving voltage illustrated in FIG. 3A, the driving timing of adjacent electrodes is shifted by Δt and the driving voltage is applied, and thereby a variation in which a potential difference is generated between the adjacent electrodes is provided. In the first example, since a potential difference is generated between the adjacent electrodes before the start of application of a driving voltage for display to a pixel B and at the time of ending of application of a driving voltage for display to a pixel A, the migrating particle group 11 present between the back surface side electrodes 4 is attached to either side of the back surface side electrodes 4 side. In addition, the time Δt is a time sufficient to move the particles between the adjacent electrodes, and is the time equal to or more than the time (pixel selection time) when each pixel is scanned in an active matrix type or a passive matrix type. In addition, the timing when application of a driving voltage starts may be made equal so as to delay the timing when application of the driving voltage ends, or the timing when application of the driving voltage may be delayed so as to make the timing when application of the driving voltage ends equal.

In the second example of the driving voltage illustrated in FIG. 3B, the magnitudes and the lengths of driving voltages applied between the adjacent electrodes are changed, and thereby a variation in which a potential difference is generated between the adjacent electrodes is provided through the entire application period of the driving voltages. In this example, a driving voltage −V is applied to the pixel A, a driving voltage −V′ (|−V|>|−V′|) is applied to the pixel B at the same timing as in pixel A, and the timing when the application of the driving voltage to the pixel B ends is delayed by time Δt. Thereby, since a potential difference is generated between the adjacent electrodes in the application period of the driving voltage for display, the migrating particle group 11 present between the electrodes during the period is attached to either side of the back surface side electrodes 4. In addition, in this example as well, the time Δt is the time equal to or more than the time (pixel selection time) when each pixel is scanned in an active matrix type or a passive matrix type. Further, driving voltages of the pixel A and the pixel B may be the same, and a potential difference may be only |V′| for Δt from the time when application of the voltage to the pixel A ends to the time when application of the voltage to the pixel B ends, or the timing when application of driving voltages ends may be the same (Δt=0), a potential difference may be only |V−V′| during a period when voltages are applied to both the pixel A and the pixel B. In the second example, since the magnitudes and the application time of voltages applied between the substrates are changed between the electrodes, in a case where the pixel A and the pixel B display the same display density, the magnitudes and the application time of the voltages may be set such that products (the area of the hatched portions in FIG. 3B) of the magnitudes and the application time of the voltage are the same so as not to vary the display density.

In the third example of the driving voltage illustrated in FIG. 4A, the driving voltage has two steps. In the initial first step of the two steps, a first voltage with the magnitude for detaching particles attached to the substrate is applied, and in the second step, a second voltage which has an absolute value smaller than the absolute value of the first voltage and a polarity equal to the polarity of the first voltage is applied, and thereby the detached particles are attached to the substrate. That is to say, an amount of particles to be detached is controlled by the first voltage, and the particles detached from one substrate are attached to the other substrate by the second voltage. In addition, in the second step (an application time of the second voltage), a driving voltage −V′ is applied to the pixel A, a driving voltage −V″ (|−V′|>|−V″|) is applied to the pixel B at the same timing as in the pixel A, and the timing when application of the driving voltage to the pixel B ends is delayed by time Δt. Thereby, a variation in which a potential difference is generated between the adjacent back surface side electrodes 4 is provided. Further, driving voltages of the pixel A and the pixel B may be the same, and a potential difference may be only |V″| for Δt from the time when application of the voltage to the pixel A ends to the time when application of the voltage to the pixel B ends, or the timing when application of driving voltages ends may be the same (Δt=0), a potential difference may be only |V′−V″| during a period when voltages are applied to both the pixel A and the pixel B.

The fourth example of the driving voltage illustrated in FIG. 4B relates to another example of the driving voltage which has two steps. In the fourth example, in an initial first step of the two steps, a first voltage with the magnitude for detaching particles attached to the substrate is applied, and in the second step, a second voltage which has an absolute value smaller than the absolute value of the first voltage and a polarity opposite to the polarity of the first voltage is applied, and thereby particles which float, without being attached to the other substrate of particles detached by the first voltage, are attached to the original substrate. In other words, although, in the third example, the particles are detached from one substrate by the first voltage and are attached to the other substrate by the second voltage, in the fourth example, after the particles are temporarily detached from one substrate and are attached to the other substrate by the first voltage, particles which are not attached to the other substrate of the particle detached from one substrate by the first voltage are attached to the original substrate by the second voltage.

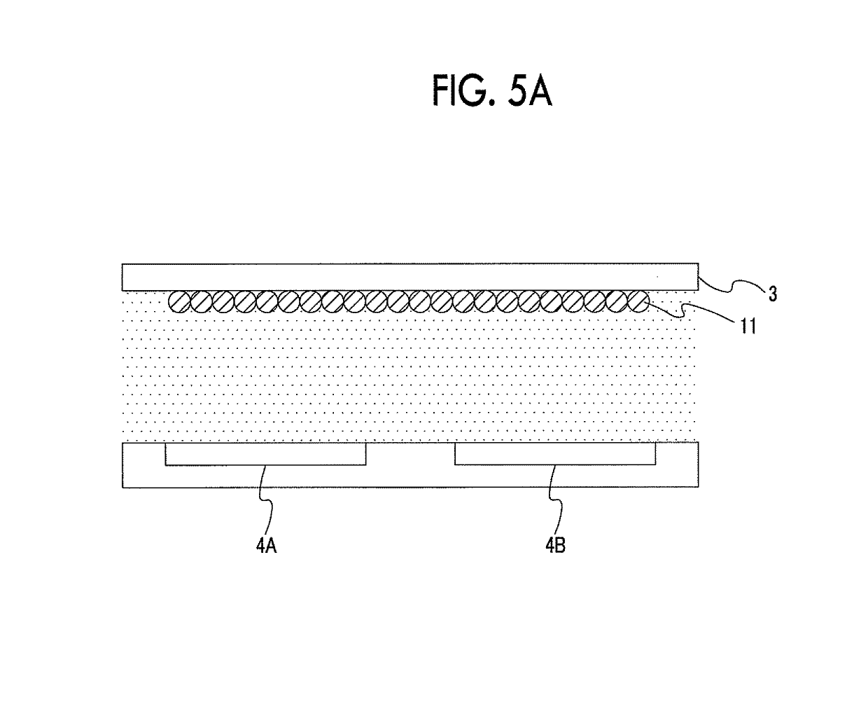

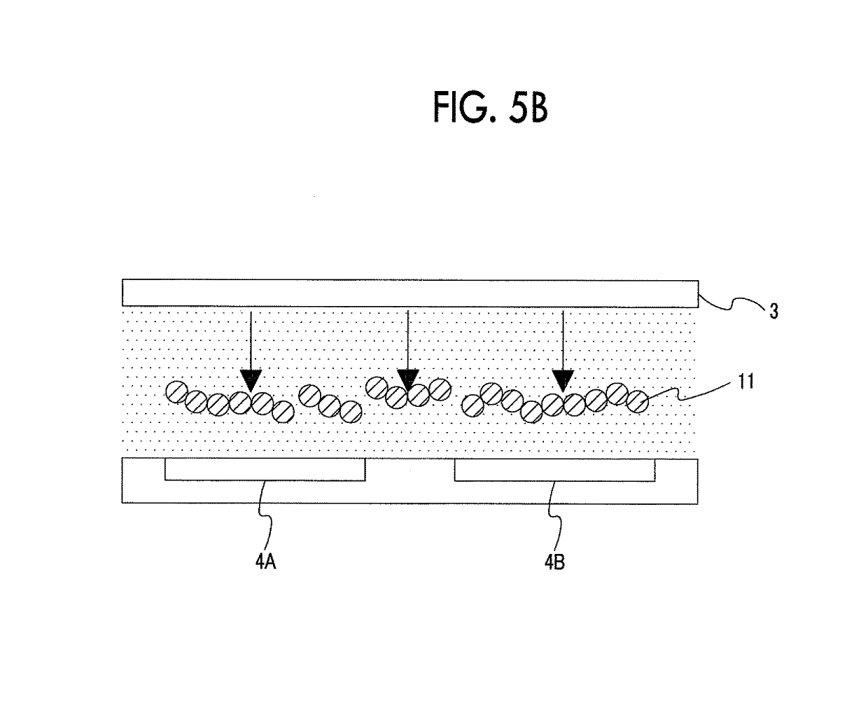

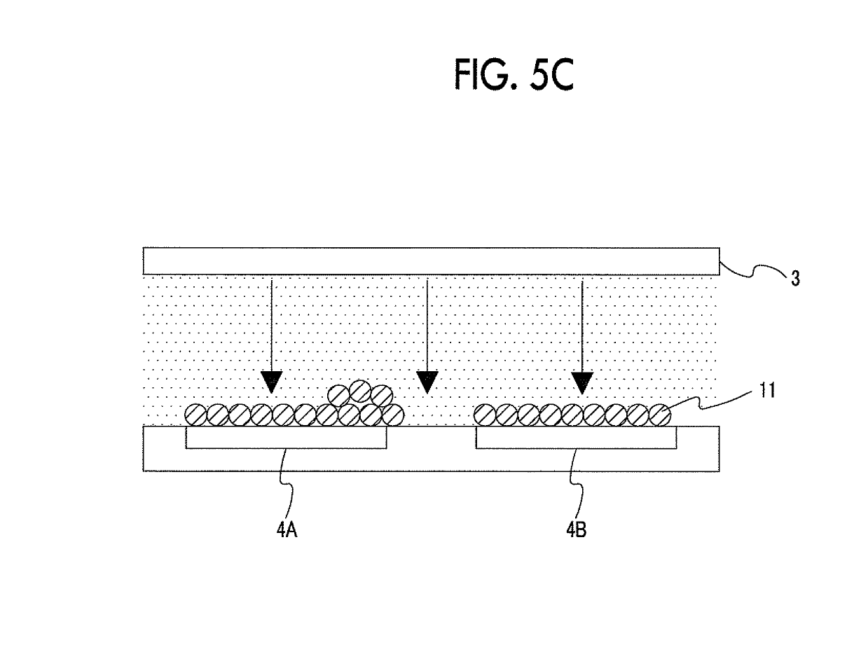

Next, an operation of the image display apparatus according to the exemplary embodiment configured in the above-described way will be described. FIG. 5 is a diagram illustrating an operation of the image display apparatus 100 according to the exemplary embodiment.

For example, as illustrated in FIG. 5A, in a case where the migrating particle group 11 moves to the back surface side electrode 4 side from a state of being attached to the display side electrode 3 side, the controller 40 controls the voltage applying unit 30 such that, in the exemplary embodiment, a variation in which a potential difference is generated between the back surface side electrodes 4A and 4B is provided in a period such as the time when application of a voltage for display to either of the adjacent back surface side electrodes 4 ends, and a driving voltage is applied between the substrates. As the driving voltage, any one of FIGS. 3A and 3B and FIGS. 4A and 4B described above is employed.

Thereby, when application of a voltage between the substrates starts, as illustrated in FIG. 5B, the migrating particle group 11 starts moving to the back surface side electrode 4 side.

In each case of FIGS. 3A and 3B and FIGS. 4A and 4B, since there is the variation in which a potential difference is generated between the back surface side electrodes 4, the migrating particle group 11 moves to the back surface side electrode 4 side. In addition, the migrating particle group 11 between the back surface side electrodes 4 moves to the back surface side electrode 4 in a direction corresponding to a potential difference between the back surface side electrodes 4, and thus the migrating particle group 11 is not attached between the back surface side electrodes 4A and 4B but is attached to either side of the back surface side electrodes 4 according to the potential difference between the electrodes. In addition, in any case, since there is the variation in which a potential difference is generated between the back surface side electrodes 4 when application of a driving voltage to the back surface side electrode 4A ends, the migrating particle group 11 between the back surface side electrodes 4 moves in a direction according to the potential difference between the back surface side electrodes 4. Thereafter, as illustrated in FIG. 5C, in a state where the migrating particle group 11 is not attached between the back surface side electrodes 4A and 4B and is attached to either side of the back surface side electrodes 4 according to the potential difference between the electrodes, application of the driving voltage to the back surface side electrode 4B ends.

As above, in a driving voltage for driving the migrating particle group 11, a variation in which a potential difference is generated between adjacent electrodes is provided, and thereby the migrating particle group 11 is suppressed from being attached between the electrodes. Therefore, deterioration in the controllability of the migrating particle group 11 is suppressed in subsequent driving.

In addition, although, in the above-described exemplary embodiment, an example where a time for generating a potential difference between the back surface side electrodes 4 is provided when application of a driving voltage of the migrating particle group 11 to the back surface side electrode 4A ends has been described, the invention is not limited thereto, the time may be provided at any timing in a period when a driving voltage is applied, in a period when application of a driving voltage to either of adjacent electrodes starts, or in a period when application of the driving voltage is in progress. However, providing a potential difference between adjacent electrodes in a period when application of a driving voltage to either of the adjacent electrodes ends may achieve a larger effect of enabling the migrating particle group 11 not to be attached between the electrodes.

In addition, in the above-described exemplary embodiment, in a case where a driving voltage has two steps as in FIGS. 4A and 4B, an example where there is a variation in which a potential difference is generated between the back surface side electrodes 4 in the second step has been described; however, the invention is not limited thereto, and a variation in which a potential difference is generated between the back surface side electrodes 4 may be provided in the first step (an application time of the first voltage). However, in the examples of FIGS. 4A and 4B, an amount of particles to be detached is controlled in the first step, and, of the particles detached in the first step, the particles which are not attached to the substrate but float, are attached to either of the substrates in the second step. In other words, the first step determines the display density, and the second step does not influence the display density. Therefore, a variation in which a potential difference is generated between the adjacent electrodes is provided in the second step, and thereby it is possible to suppress particles from being attached between the adjacent electrodes without influencing the display density.

In addition, in the above-described exemplary embodiment, control of the voltage applying unit by the controller 40 may be realized by hardware or realized by executing a software program. Further, the program may be recorded on various recording media and be distributed.

The foregoing description of the exemplary embodiments of the present invention has been provided for the purposes of illustration and description. It is not intended to be exhaustive or to limit the invention to the precise forms disclosed. Obviously, many modifications and variations will be apparent to practitioners skilled in the art. The embodiments were chosen and described in order to best explain the principles of the invention and its practical applications, thereby enabling others skilled in the art to understand the invention for various embodiments and with the various modifications as are suited to the particular use contemplated. It is intended that the scope of the invention be defined by the following claims and their equivalents.

What is claimed is:

1. A driving device of an image display medium which includes a pair of substrates having a transparent display substrate and a back substrate disposed so as to be opposite to the display substrate with a gap therebetween, a first electrode provided on the display substrate side, a plurality of second electrodes provided on the back substrate side, and particles sealed between the pair of substrates and detached from either of the pair of substrates by a voltage applied to the pair of substrates in a state of being attached to the substrate, and which displays an image on the basis of image information,
the driving device comprising:
a voltage applying unit that applies a voltage to the pair of substrates of the image display medium; and
a controller that controls the voltage applying unit on the basis of the image information such that a variation of a driving voltage between adjacent second electrodes is provided with respect to adjacent pixels that display the same density.

2. The driving device of the image display medium according to claim 1, wherein
the variation of the driving voltage includes at least one of:
the variation of application time of the driving voltage between the adjacent pixels, and
the variation of each voltage value applied to the adjacent pixels.

3. The driving device of the image display medium according to claim 1, wherein the controller controls the voltage applying unit such that as the driving voltage, a first voltage with the magnitude for detaching particles attached to either of the pair of substrates at an amount corresponding to the image information is applied, and a second voltage of which an absolute value is smaller than the absolute value of the first voltage is applied following the first voltage.

4. The driving device of the image display medium according to claim 3, wherein
the variation of the driving voltage includes:
the variation of application time of the second voltage by the adjacent pixels, and
the variation of a value of the second voltage by the adjacent pixels.

5. The driving device of the image display medium according to claim 3, wherein
each area that is set by a voltage value and an application time of each driving voltage between the adjacent pixels is substantially equal.

6. An image display apparatus comprising:
an image display medium that includes a pair of substrates having a transparent display substrate and a back surface substrate disposed so as to be opposite to the display substrate with a gap therebetween, a first electrode provided on the display substrate side, a plurality of second electrodes provided on the back surface substrate side, and particles sealed between the pair of substrates and detached from either of the pair of substrates by a voltage applied to the pair of substrates in a state of being attached to the substrate, and that displays an image on the basis of image information; and
the driving device of the image display medium according to claim 1.

7. A driving method of an image display medium which includes a pair of substrates having a transparent display substrate and a back surface substrate disposed so as to be opposite to the display substrate with a gap therebetween, a first electrode provided on the display substrate side, a plurality of second electrodes provided on the back surface substrate side, and particles sealed between the pair of substrates and detached from either of the pair of substrates by a voltage applied to the pair of substrates in a state of being attached to the substrate, and which displays an image on the basis of image information,
the driving method comprising:
applying a voltage to the pair of substrates of the image display medium, and
controlling the voltage applying unit on the basis of the image information such that a variation of a driving voltage between adjacent second electrodes is provided with respect to adjacent pixels that display the same density.

8. A non-transitory computer readable medium storing a driving program causing a computer to function as the controller of the driving device of the image display medium according to claim 1.
